(19) United States
(12) Patent Application Publication
(10) Pub. No.: US 2014/0127667 A1
(43) Pub. Date: May 8, 2014

(54) LEARNING SYSTEM

(71) Applicant: Marco Iannacone, Milan (IT)

(72) Inventor: Marco Iannacone, Milan (IT)

(21) Appl. No.: 14/069,130

(22) Filed: Oct. 31, 2013

Related U.S. Application Data
(60) Provisional application No. 61/722,662, filed on Nov. 5, 2012.

(51) Int. Cl. G09B 5/02; G06F 3/0483

(52) U.S. Cl. CPC G09B 5/02; G06F 3/0483
USPC 434/379

(57) ABSTRACT

A tablet interface learning device includes school books, narrative books, comics and written material on the device selectively are loaded and there is a scanner with automatic document feeder for acquiring document. There is a user interface (UI) screen, the interface screen having big icons, each of the icons occupying about 15 and 30% of the interface screen. A text to speech functionality includes an ebook that can be read aloud by the device itself, and includes an icon of the ebook toolbar to activate the text to speech starting from the first word of the shown page. An education or studying method and system includes a mapping tool representing the main concepts of a topic to study.

### CROSS REFERENCE TO RELATED APPLICATION

This application claims priority from and is related to U.S. Patent Application Ser. No. 61/722,662, entitled Learning System, filed Nov. 5, 2012. This application is incorporated herein by reference in its entirety.

### BACKGROUND

This disclosure relates to a learning system and more specifically to a system, application and method for learning for young students having dyslexia (or other learning disabilities).

### SUMMARY

In the present disclosure, an education or learning method and system comprises an hardware and software platform having a tablet device, the tablet interface being a primary learning device. School books, narrative books, comics and written material can be loaded on the device selectively by at least one of wifi, usb or microsd card.

Optionally there is a scanner with automatic document feeder for acquiring documents. An optional head mounted display with camera can also capture text and documents in real time.

A Tablet for Dyslexic Child (TDC) is provided comprising hardware and software that enable workflows that can transform a collection of text, data & information that appear confused and unmanageable to a dyslexic mind into a new document or format where data are structured and represented in a different way, integrated with data from external sources such as images, voices and/or new text so that they can be understood, studied and remembered by dyslexic students.

There is a user interface (UI) screen, the interface screen having big icons, each of the icons occupying from 10 to 30% of the interface screen (depending on the implementation).

By being able to define a learning system as disclosed significant advantage is attained with the method, system, and application of the disclosure.

Many advantages and features of the disclosure will become readily apparent from the following detailed description of the disclosure and the embodiments thereof, and from the accompanying drawings.

### DRAWINGS

The above-mentioned features and objects of the present disclosure will become more apparent with reference to the following description taken in conjunction with the accompanying drawings wherein like reference numerals denote like elements and in which:

FIG. 1 is perspective view of the present disclosure showing a front view of the Tablet for Dyslexic Child (TDC).

FIG. 2 is a view of the present disclosure showing a logical view of a possible internal technical components useful to implement the described technology. The figure shows all the available connections/interfaces to external devices.

FIG. 3 is a view of the present disclosure showing a side view of possible implementation of TDC. Available slot and connections are shown there.

FIG. 4 is a view of a possible embodiment of the UI with big icons and parental control

FIG. 5 is a view of the present disclosure showing one possible implementation of the diary/agenda application.

FIG. 6 is a view of the present disclosure showing one possible implementation of the opening screen of the ebook reader. In this particular implementation a preview of the available books is shown together with some information extracted from the ebook meta-tags. Available ebooks can be group by category, language and other criteria. It is also possible to import ebooks from external storage or to buy them on the Internet.

FIG. 7 is a view of the present disclosure showing a possible implementation of the ebook reader full screen view. At the bottom the ebook reader toolbar is shown. This toolbar disappears after few seconds leaving the full screen space to the ebook.

FIG. 8 is a view of the present disclosure showing a possible implementation of the text to speech toolbar which can be invoked from the main ebook toolbar. From this toolbar it is possible to select the word the read aloud can start from. The reading can also be paused, stopped and restarted.

FIG. 9 is a view of the present disclosure showing a possible implementation of the karaoke-like reading within the ebook reader program. The word forest is highlighted in yellow being the one that is read aloud in that moment. Within ebook settings it is possible to choose if is better to highlight individual words or the whole sentence that is being read.

FIG. 10 is a view of the present disclosure showing a possible implementation of the selection mechanism within the ebook reader. During the selection the text of the desired area is zoomed in so that it is easier to touch the exact word the selection should start from.

FIG. 11 is a view of the present disclosure showing a possible implementation of the special keyboard. Figure is showing: the mistyped words of an Italian text which is autocorrected on the keyboard itself prior to be insert it in the document, the possibility to dictate the text via the microphone, the spell check which highlights in red wrong words within the writing program and also the simplified keyboard (capital letters and colored keys)

FIG. 12 is a view of the present disclosure showing a possible implementation of the onboard Multilanguage dictionary where a search as you type of an Italian word is shown.

FIG. 13 is a view the present disclosure showing a possible implementation of the onboard Multilanguage dictionary where a search results of an Italian word (“Preistoria”) is shown and the possibility to read aloud the definition by tapping on the icon.

FIG. 14 is a view the present disclosure showing a flowchart representing a possible implementation of the learning methodology described here.

FIG. 15 is a view of the present disclosure showing a possible implementation of the writing toolbar that can be invoked by the ebook reader main toolbar. From here students can highlight text, write notes, add vocal notes, draw a shape on top of the text/images or insert a blank page (to write homework in) within an existing ebook.

FIG. 16 is a view of the present disclosure showing a possible implementation of the search toolbar that can be invoked from the main ebook reader toolbar. Once a student selects a word using this toolbar he can search it in the local dictionary, on Google or Wikipedia. Additionally he can copy it in memory to be used by other applications (or by the mapping program via a specific sharing mechanism—see FIG. 22).

FIG. 17 is a view of the present disclosure showing a possible implementation of one of the components of the voice calculator: the abacus. As shown in the pictures in addition to the traditional analogue mechanism, this abacus is also showing the numeric value after the calculation and it is able to read it aloud.

FIG. 18 is a view of the present disclosure showing a possible implementation of one of the components of the voice calculator: the twenty fingers tool. Calculation is performed by raising or lowering the fingers. Numbers are shown at the edge of each individual finger. The result can be read aloud by tapping an icon.

FIG. 19 is a view of the present disclosure showing the splash screen of a possible implementation of the diagram app where students can select an existing map or design a new one.

FIG. 20 is a view of the present disclosure showing a possible embodiment of the simple mechanism that is used to create and connect nodes within the diagram app.

FIG. 21 is view of the present disclosure showing a possible implementation of the dialogue box used to modify the properties of the nodes within the diagram app.

FIG. 22 is a view of the present disclosure showing a possible mechanism to save and categorize highlighted keywords from the ebook reader to be used to create maps within the diagram app.

FIG. 23 is a view the present disclosure showing a possible implementation of cloud based mechanism that allow teachers to exchange digital documents with students and vice versa.

FIG. 24 is a view the present disclosure showing a flow chart where a possible transformation of a written text into a completely different representation (a visual map) that is fully digestible by the dyslexic mind.

FIG. 25 is a view of the present disclosure showing the transformation/decomposition of homework assigned by the teacher in a sequence of events/activities that can be managed by a dyslexic mind and allow the student to understand and execute it.

FIG. 26 is a view of the present disclosure showing a possible embodiment of a collaborative learning enabled by the adoption of TDC.

FIG. 27 is showing the different brain zones activated in a dyslexic mind compared to a typical reader one

FIG. 28 is a view of a possible workflow using TDC different hardware and software module to convert a printed (static) text (28.1) into a usable and accessible one. The I/O webcam module (28.8) acquires the printed page taking a picture, the data is passed to the CPU module (28.3), then after its memorization via I/O storage module (28.4), the picture transformation module comes in transforming the digital picture in meaningful data using CPU module (28.3) to perform optical character recognition subroutine. The ebook tweak engine then can come in (28.7) and apply all the tweaks to make it more readable (such as increasing line spacing, increase words spacing, apply more readable fonts, etc). At this point the video module can show the transformed text on screen (28.8) and once is saved (28.9) the student can reproduce it as an audio with karaoke effects via audio (28.10) and video (28.11) modules

FIG. 29 is a view of a possible embodiment of different map's shapes that can be used to structure data and its relations in mapping program.

FIG. 30 is a view the present disclosure showing a vertical view of the two side of the device with available buttons. In this particular implementation an infrared interface is also shown which allows bidirectional communication with appliances and remote controls.

FIG. 31 is a view of a possible workflow using TDC optional Camera Glass (HMD) using different hardware and software module to convert a printed (static) text (31.1) into an understandable one, in real-time. The video camera on HMD (31.2) acquires the printed page, the data is passed in real-time to the CPU module (31.3), then after video stabilization module (31.4) and OCR subroutine, meaningful data are stored via I/O module. Identified text can then be read aloud by the audio module (31.8) and/or karaoke like highlighting layer can be projected on the glass itself.

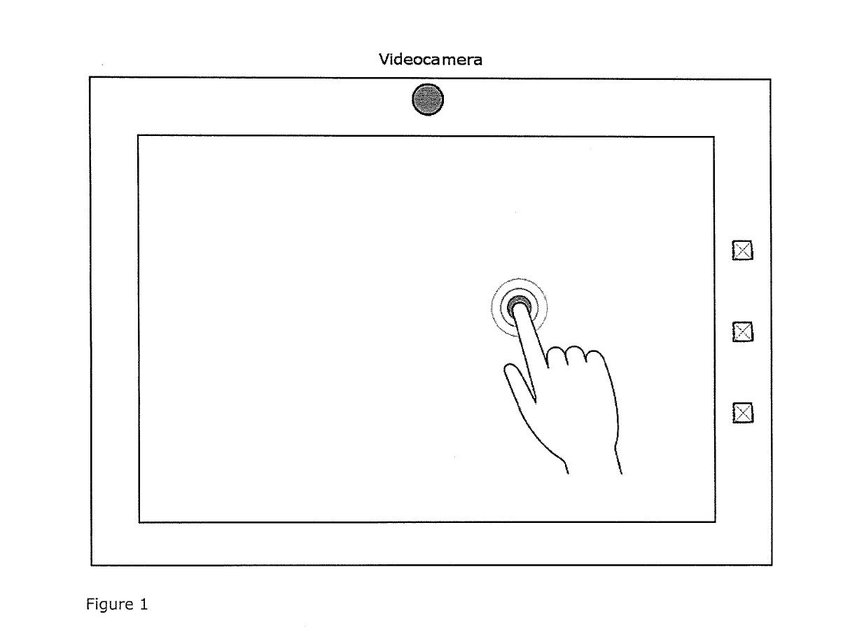

### DETAILED DESCRIPTION

The disclosure is capable of being implemented in embodiments in many different forms. There are shown in the drawings and will be described herein, in detail, some of the embodiments of the present disclosure. The present disclosure is to be considered an exemplification of the principles of the disclosure and is not intended to limit the spirit or scope of the disclosure and/or the embodiments illustrated.

An education or learning method and system comprises an hardware and software platform having a tablet device. The tablet interface is a primary learning device.

School books, narrative books, comics and written material are loaded on the device selectively be at least one of wifi, usb or microsd card. Optionally, there is a scanner with an automatic document feeder for acquiring documents. An optional head mounted display with camera can also capture text and documents in real time.

A single device comprises hardware and software that enable workflows that transforms a collection of text, data & information that appear confused and unmanageable to a dyslexic mind. A new document or format is developed where data are structured and represented in a different way, integrated with data from external sources such as images, voices and/or new text.

There is a user interface (UI) screen, the interface screen having big icons, each of the icons occupying from about 10 to 30% of the interface screen (depending on the implementation).

An education method comprises hardware and software platform having a tablet device, the tablet interface being a primary learning device; and selectively a scanner with automatic document feeder for acquiring documents.

There are the steps of
loading at least one of a school book, narrative book, comic or written material on the device selectively by at least one of wifi, usb or microsd card; and
selectively providing the interface with a functionality of parental control that allows a teacher or parent to choose the application for a child, and other applications essentially being non-available visually on the device.

A panel (PIN protected) permits a teacher or parent to reconfigure the device with different programs or to access other available applications to allow the student to play (as a recognition/reward) for a good work.

There is an agenda with recording/dictating capabilities, school timetable, different colors, alarms/reminders to simplify the process for a child to take notes and not forget homework.

In an edit mode it works in a traditional way where the user can choose a day by selecting it in the week/month view and type a homework with all the details; and selectively additionally homework can be added by recording them on the current day and permitting a student to listen to this again as needed. Typed homework can also be read aloud in the agenda via a Text to Speech functionality.

In a view mode, homework in the traditional week view is shown, and also in a single to do list where homework is shown in a chronological order according to the due date.

An ebook reader is functional to reproduce common digital format selectively as txt, HTML, epub, or PDF. The ebook reader includes a touch interface to permit browsing ebooks which once opened, become the only thing shown on the screen.

A Text To Speech (TTS) functionality includes an ebook can be read aloud by the device itself, and including an icon of the ebook toolbar to activate the text to speech starting from the first word of the shown page.

The ebook reader includes a karaoke functionality that visually highlights on screen the sentence that is being read by the text to speech engine.

An on-screen keyboard includes a dictating feature, an on-the-fly spell checker of what is typed, highlighting relative to an internal dictionary, and an option for read aloud. For younger kids there is also a simplified layout with colored and simplified keys.

An education or studying method and system includes a mapping tool to permit representing the main concepts of a topic they need to study in a map.

A multi-language dictionary can run as a standalone application or invoked within a different app (such as the ebook reader), and selectively the dictionary performs search as you type feature that shows on the fly words matching the letters that has been inserted. The dictionary is also able to read aloud the definition matching the query via a Text To Speech functionality

An office suite with text to speech functionalities, spell check and possibility to incorporate data from other programs is also available and it can be used by the students to produce essays, compositions, letters, school papers, etc

The disclosure is directed to a method of learning focused on people such the ones suffering from dyslexia.

Dyslexia is a broad term that is often used to refer to learning difficulties that affect a person's ability to perform some basic tasks such as reading, performing basic calculation (Dyscalculia), writing, etc. In this disclosure, the term dyslexia refers to this broader term and not specifically to the reading difficulty only.

Studies show that this problem affects 13% of people (and students) worldwide (percentage varies per country due to the different language specifics). Dyslexic children are not stupid, they just have a brain that works differently therefore some activities are more difficult for them than typical readers.

For this reason—if not helped properly—those kids often have difficulties at school. Lack of knowledge of the root reason of their difficulties can also decrease the kid's level of self-confidence and interest in learning. In the past those kids were considered often lazy or even stupid but medical researches proved that dyslexia is not determined by a low I.Q.

Though dyslexia was first described over a century ago, it has only been in the last two decades that neuroscientists have determined the neural systems influencing reading and dyslexia. To a significant extent, this explosion in understanding the neural bases of reading and dyslexia has been driven by the development of functional neuroimaging—technologies such as positron emission tomography (PET) and functional magnetic resonance imaging (fMRI) that measure changes in metabolic activity and blood flow in specific brain regions while subjects are engaged in cognitive tasks (Frackowiak et al., 2004).

A dyslexic mind works in a different way than a typical reader one.

Due to this neurological difference, dyslexic people, perceive the world in a different way: they might be unable to properly position a sequence of events, or have difficulties in picturing—out of a page full of words—the overall meaning of a story, or might not properly see numbers therefore have difficulties to perform simple calculation, etc

Kids affected with Dyslexia are generally helped in two ways:
via medical therapies performed by Neuropsychiatric and Speech therapists who assign them specific exercise to increase phonologic understanding and help them to acquire some automatism;
by allowing kids to use compensating tools (PCs with specific software) at school and home.

This disclosure includes an education/studying methodology—performed via an hardware and software platform that herein is called the “Tablet for Dyslexic child” (TDC)

Tablet computers have many advantages not found in standard desktop or notebook computers. One of the most significant advantage is the ability to interface with the tablet by writing on or tapping on a touch screen display using fingers or even a stylus. Input to the tablet can be done in a similar way to writing on paper but also using a virtual keyboard. By the term “tablet” the Applicant includes a mobile computer with display, CPU and battery in a single unit. These computers can be equipped with sensors selectively like a camera, microphone, accelerometer, compass, proximity and more. They provide a user interface that is more natural than a standard PC. The interface for tablet as defined can be based on a touch screen, gesture recognition, or voice commands, etc. In some embodiments, the tablet can be with the ability to provide a screen projecting image on other surfaces such as wall, floors, desks, glasses etc. and optionally using the camera, microphone or other sensors to interact with users.

This approach is generally perceived as more intuitive and natural than the traditional PC and for this reason within the Human Computer Interaction model they are in the so called Natural User Interfaces (or NUI). For some Dyslexic children, typing (on a virtual or physical keyboard) is easier than writing with a pen on paper.

Additionally recent researches (Noel 2005, Penner-Wilger & Anderson, 2008) proved that there is a neurobiological correlation between finger manipulation & touch and numeric calculation capabilities; stimulation provided by touching activities on electronic devices can generate long term benefits in spatial orientation and even on calculation capabilities on young minds (Giorgi & Baccaglini-Frank, 2011)

User interfaces are generally simplified in tablet PCs and we simplified it even more in TDC making it more suitable for younger.

### 1. Previous Studying Methods for a Dyslexic Child

As a dyslexic child can have difficulties in performing some basic tasks, in many countries they are allowed (by law) to use some tools to help them in performing those activities at school and while studying.

They generally use laptops with some specific software preloaded in particular:
Text readers: which allow to reproduce aloud written text of a document or a web page with a synthetic voice (so called text-to-speech mechanism);
Voice calculators: software calculator that repeat the input and output number via a synthetic voice (so called text-to-speech mechanism);
Voice recognition software: which allow them to input text just speaking aloud (dictating programs);
Dictionary, spellcheckers and auto correction.

Those solutions—although able to support students—are often complicated, heavy to bring around and perceived by kids as prosthesis similar to the ones used by people with disabilities.

### 2. The Disclosed Learning Tool: TDC

The disclosed Tablet for Dyslexic child (“TDC”) although has a simple interface specifically designed for kids, is a powerful and complete computing device.

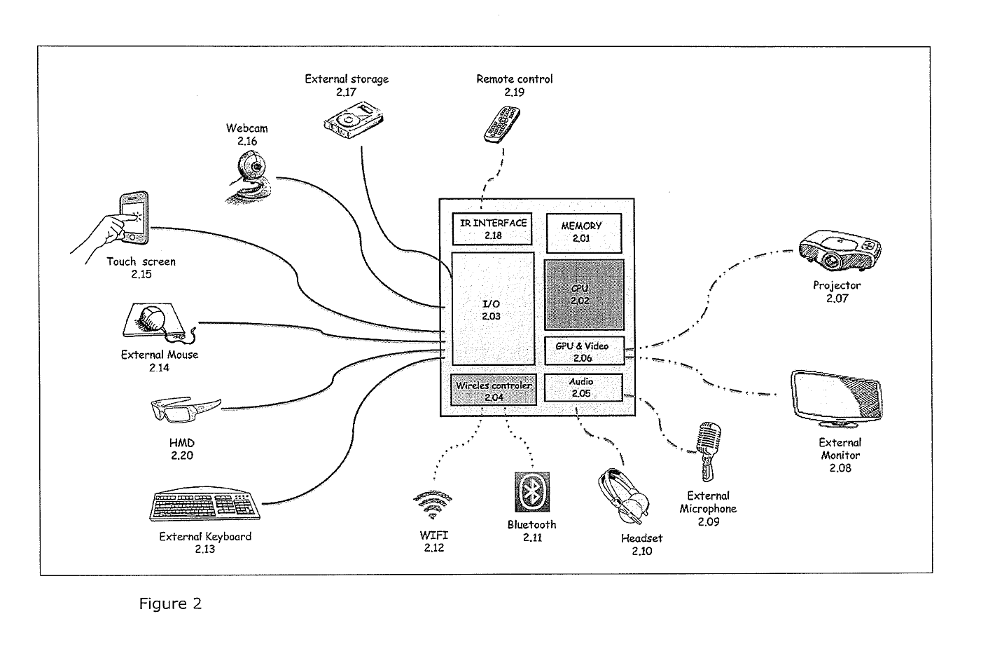

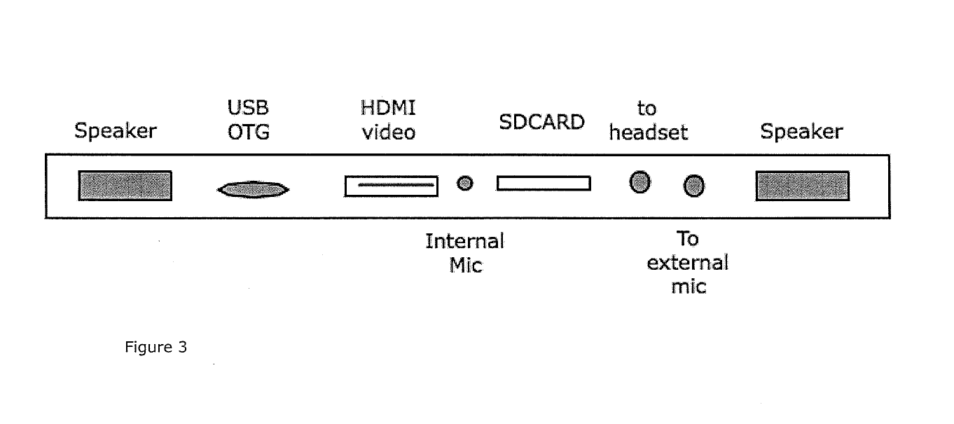

FIG. 2 illustrates the internal technical components of TDC and its possibility to interact with external devices/persons.

It contains some of the elements of a general purpose computer system: a CPU (2.02) is using a memory controller (2.01) able to manage several GB of RAM, an input/output (I/O) controller (2.03) allows to interact with several external elements such as flash USB, micro SD card or other external storage (2.17), external keyboard (2.13), external mouse (2.14), touch screen (2.05), a webcam (2.16), glasses with integrated camera-head mounted display (2.19), etc

A wireless controller (2.04) allows to connect Bluetooth devices (2.11) or to use wifi/3G or 4G to access a local network and the Internet (2.12). Additionally it can control external displays using Miracast/Wireless Display protocol.

The Audio interface allows usage of external headset (2.10) and external microphone (2.09), in addition to internal speaker and onboard microphone.

In an exemplary implementation, modules for managing attachment, detachment and operation of the keyboard and other modules may be incorporated as part of the operating system, application programs, other program modules, or circuit components. Data pertaining to the management of the detachable components and other data may be stored as program data.

The disclosed disclosure is able to transform a written text (i.e. a group of individual words that for a dyslexic individual might be very tiresome to understand) in a vocal speech that is easier to handle, reproduce many times and finally understand

The disclosed disclosure can transform what a dyslexic individual sees as a collection of confused/unconnected data, text and images in a schema that his/her mind can handle, fully understand and remember.

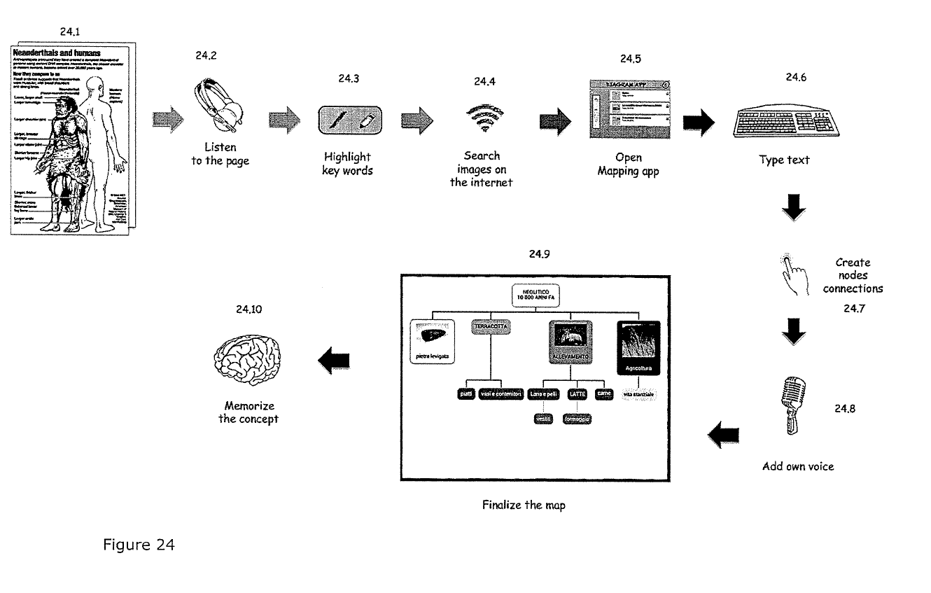

FIG. 24 illustrates a possible flowchart of activities that transforms the unintelligible/difficult to learn book into a new asset that can be easily memorized. The book is read aloud by the ebook reader (24.2), the student highlights some key words (24.3) and search on the internet pictures appropriate for the topic (24.4), then he/she launch the Mapping program (24.5), types the name of the individual nodes and adds text (24.6), create the map skeleton and interconnects the nodes (24.7), adds some vocal notes (24.8), obtains a new visual map different from the starting text and elements but representing the main concepts and their relation (24.9), uses the map to study and memorize the concept (24.10)

Tablet for Dyslexic child (“TDC”) is a device that will be generally welcomed by kids as it is considered by digital natives as a “cool” device and definitely is not viewed as a tool for people with disability. This simple fact contributes to give the methodology a good start in increasing a bit the kid's self-opinion.

Each kid is provided a TDC which becomes his/her primary learning device. School books, narrative books, comics and every written material can be loaded on the device itself via wifi, usb or microSD card.

At school/home the kids are provided with fast scanners with automatic document feeder (ADF) that allow them to acquire every kind of document.

Students can also use optional glasses with camera (head mounted display) that will be able to simplify perceived reality by enriching it with information more intelligible for them. Via an augmented reality module, a specific algorithm will process real-time video recorded by the HMD (camera glasses) recognizing written text, capturing it and reading it aloud (via audio module). Captured text can also be saved in combination to the generated voice for later usage.

The augmented reality module can be activated with voice commands, using hand gestures and/or by lunching a specific app on the tablet and/or using a special switch on the HMD itself.

2.1 The UI with Parental Control

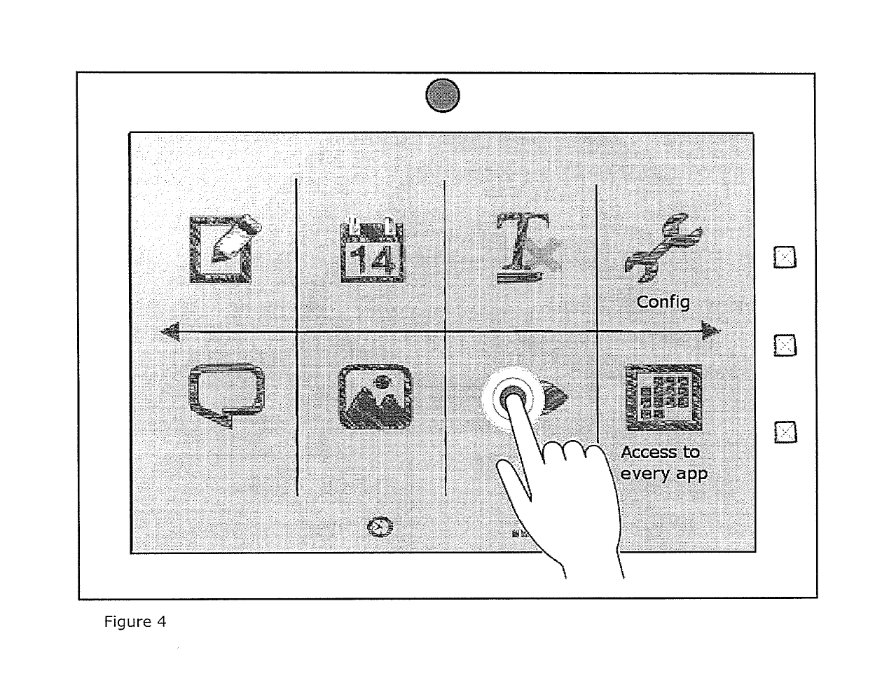

The Tablet for Dyslexic child has a special interface (UI) specifically designed for kids. It has big icons (FIG. 4) and functionalities of parental control that allow a teacher or parent to chose the application that the child can use (OPT-IN approach). Other applications, normally available on the device, are simply not shown.

A special panel (PIN protected) allows teachers or parents to reconfigure the device with different programs or to access to all the available applications to allow the kid to play (as a recognition/reward) for a good work.

This interface and control will make the “TDC” welcome also at school as it can be perceived as a real educational tool (neither a game nor a distracting device).

### 2.2 The Diary

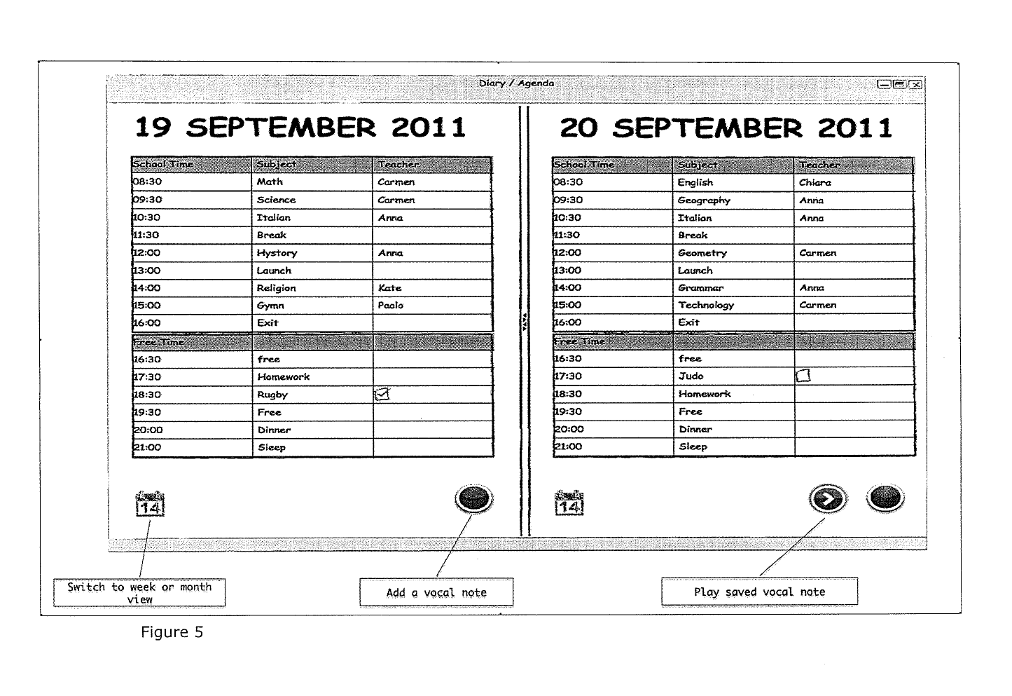

The “TDC” contains a specially designed agenda (FIG. 5) with recording/dictating capabilities, school timetable, different colors, alarms/reminders, etc to simplify the process for dyslexic children to take notes (and not forget) their homework.

It is aimed to essentially replace entirely the traditional paper diary/notebook to annotate homework.

In edit mode it works in a traditional way where the user can choose a day by selecting it in the week/month view and type a homework with all the details; additionally homework can be added just by recording them on the current day and then the student can listen them again at home every time they want.

Thanks to the built-in lesson plan component, students will be facilitated in the identification of the proper day to add homework because the diary will suggest the proper ones according to the subject of the homework.

In view mode can show the homework in the traditional week view but also in a single to do list where homework are listed in chronological order according to the due date. In both modes homework can be read aloud by the TDC.

### 2.3 Ebook Reader

The “TDC” contains an ebook reader able to reproduce most common digital format such as epub, PDF, HTML, txt, RTF, etc. Students will use such a program as their primary reading tool.

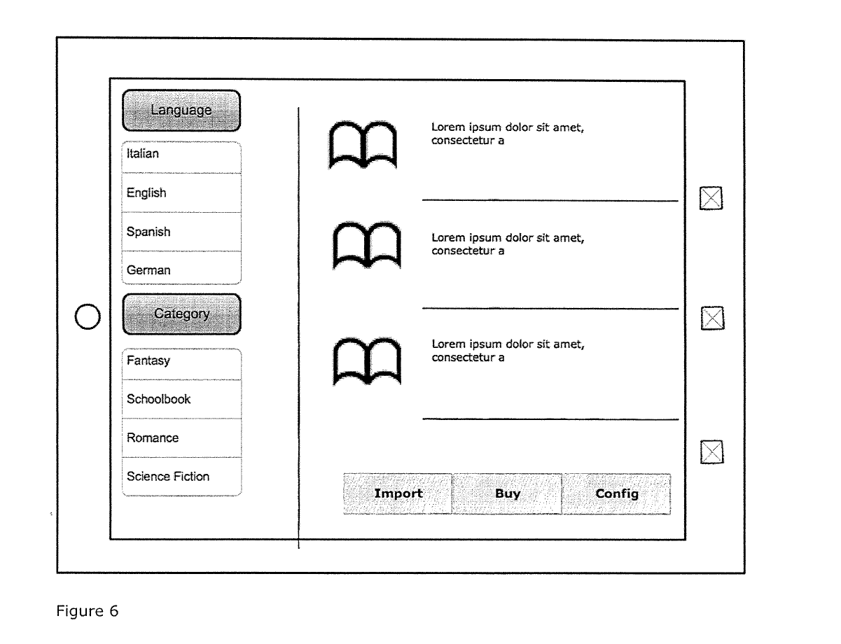

The disclosed ebook reader has a simple touch interface that allow kids to easily browse ebooks (FIG. 6) that—once opened—become the only thing shown on the screen.

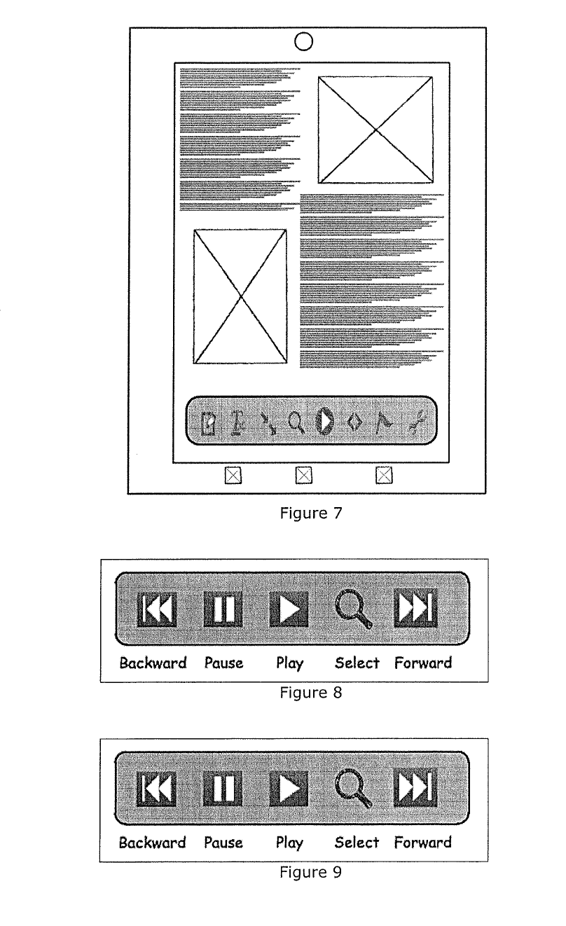

There is a toolbar with multiple commands to perform on the book but is shown only if kids are touching the screen for a prolonged time (FIG. 7). In the absence of actions, it disappears quickly: this way there are no distractions and the screen is essentially filled entirely by the ebook.

Through the “Text To Speech” (TTS) functionality, ebooks can be read aloud by the device itself. By touching a specific icon of the ebook toolbar the Text to Speech is activated starting from the first word of the shown page (FIG. 8).

The ebooks metatag allows the proper automatic selection of TTS language so that if a book is classified as “Italian” can be read aloud with Italian voice, accent and proper spelling.

Reading aloud can be
stopped before the completion of a page by pressing a specific icon paused and then restarted at student will;

Reading speed can be increased or decreased according to the student taste: it is possible to select among 5 different speed levels.

Additionally, the disclosed ebook reader has a karaoke functionality that visually highlights on screen the sentence that is being read by the text to speech engine (FIG. 9). This is useful for kids that can follow the text while listening to the voice reading in the page. Leveraging this feature, students can practice a bit the reading (with eyes) while someone else (the TDC) is doing the complex part (reading it aloud). When reading with eyes becomes too tiresome, students can just listen the voice

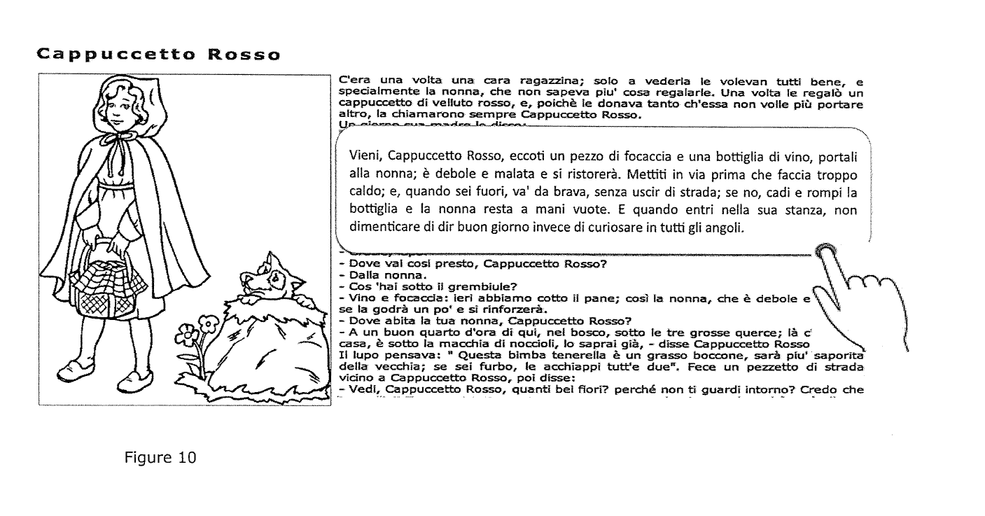

It is easy for kids to select a specific point to start from or highlight a specific paragraph to be read aloud. It is just a matter of touching two times the screen and the words they want to read (FIG. 10)

On Screen Keyboard (with Dictating Feature)

The disclosed “TDC” contains an on-screen keyboard specially designed for kids needs.

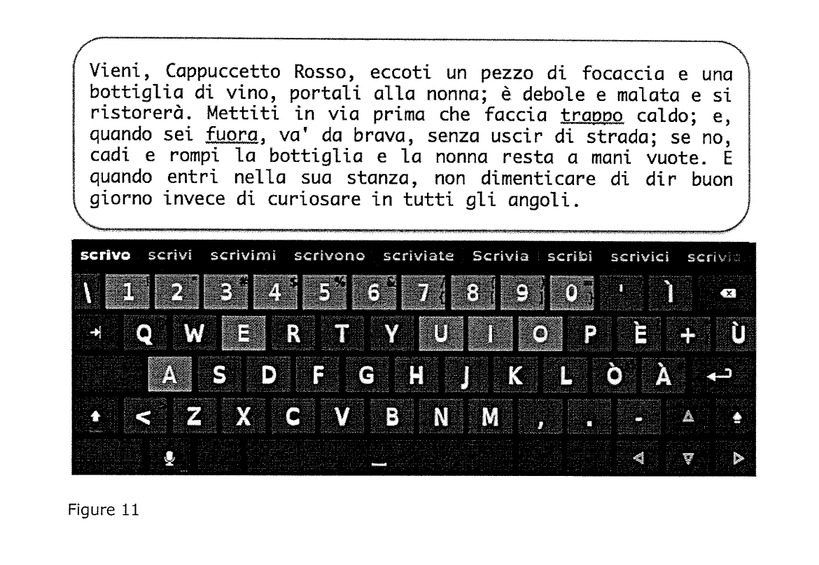

The keyboard perform on-the-fly spell checker of what students type and autosuggests the most similar word according to an internal dictionary. Additionally each word can be optionally read aloud by “TDC” (every time the user presses space) to better assist students with writing difficulties (FIG. 11).

The keyboard implements also a dictating feature with automatic character recognition, to allow students to speak instead of typing.

For younger students there is also a kid mode where keys are bigger and colored so that can be easier identified.

### 2.3 1 Mapping Program

The disclosed “TDC” provides a mapping tool that allows kids to represent the main concepts of a topic they need to study in a map. This map (or diagram) can help them to visually memorize and recover the concepts and their relations.

In fact a dyslexic child often can have difficulties in memorizing abstract concepts and sentences while he/she can have a better visual memory.

The generated maps are implementing the concept maps paradigm described for the first time by by Joseph D. Novak and his research team at Cornell University in the 1970s and further expanded in the 90s by McAleese who suggested that the process of making knowledge explicit, using nodes and relationships, allows the students to become aware of the details of what they know and—as a result—become able to modify what they know adding additional details/relations that make it more understandable.

### 2.4 Dictionary

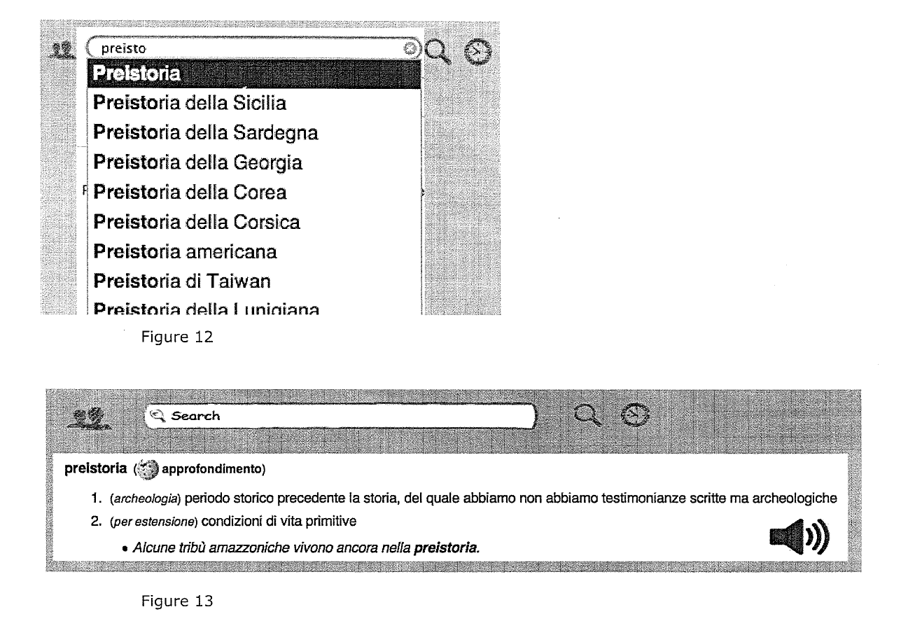

The disclosed TDC contains a multi-language dictionary that can run as a standalone application or invoked within a different app (such as the ebook reader). The dictionary provides a “search as you type” feature that shows on the fly words matching the letters that have been typed (FIG. 12).

Once found the word, its definition is shown on screen with hyperlinks to other words mentioned in the definition. The definition (and the searched word) can be read aloud by pressing an icon (FIG. 13).

A lemma definition (text) can be shown using different font size, different line spacing, only capital letters in order to simplify reading.

Tapping on a specific icon, students can also obtain the translation of that word in one of the available languages.

Such a program allows students to overcome the great difficulty to use traditional dictionary (which requires a lot of reading) and allows them to improve and enrich their vocabulary.

### 2.5 Special Typeface and Other Tweaks to Facilitate Reading

Studies showed that one of the difficulties that dyslexic individuals face in reading is that they often confuse some letters which are specular one to the other. Letter p and q, b and d are mirrored images using vertical or horizontal axis and this make them similar to dyslexic minds. It is possible to adopt some tweaks in writing text, to improve readability also for dyslexic child: increasing line spacing, using bigger font size, using only upper cases, and adopting fonts where specular letters are in reality a bit different.

The disclosed TDC provides a special font which is designed with exactly this approach in mind.

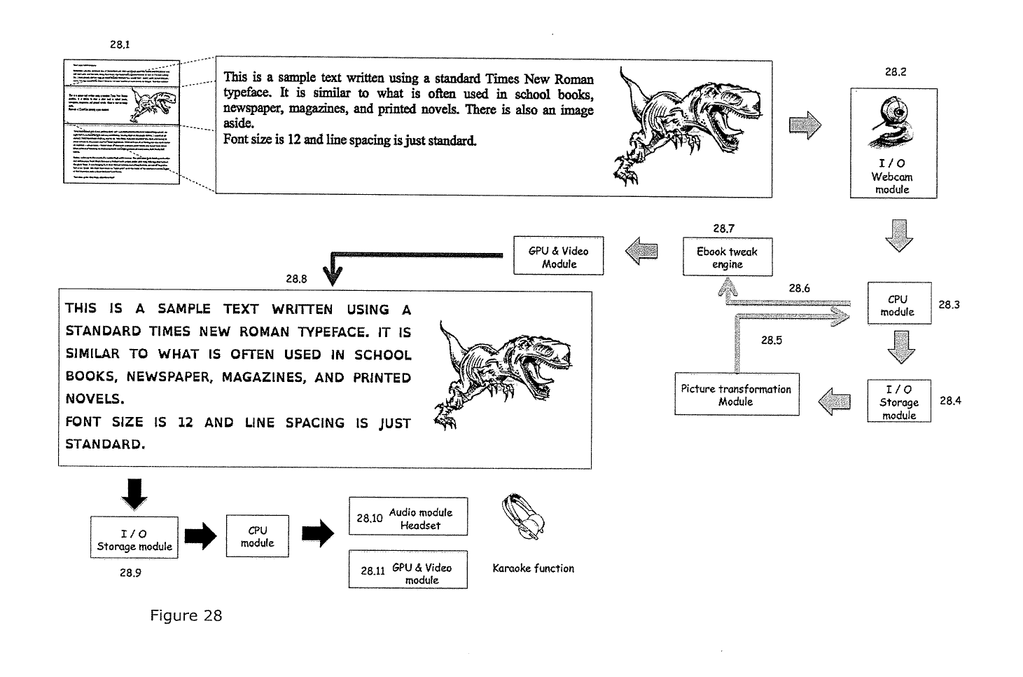

Furthermore, there is a special software module that can transform an existing printed text (or ebook) in a digital document that use some (or all) of those tweaks and show text with the special font (FIG. 28)

### 3. The Disclosed Learning Method

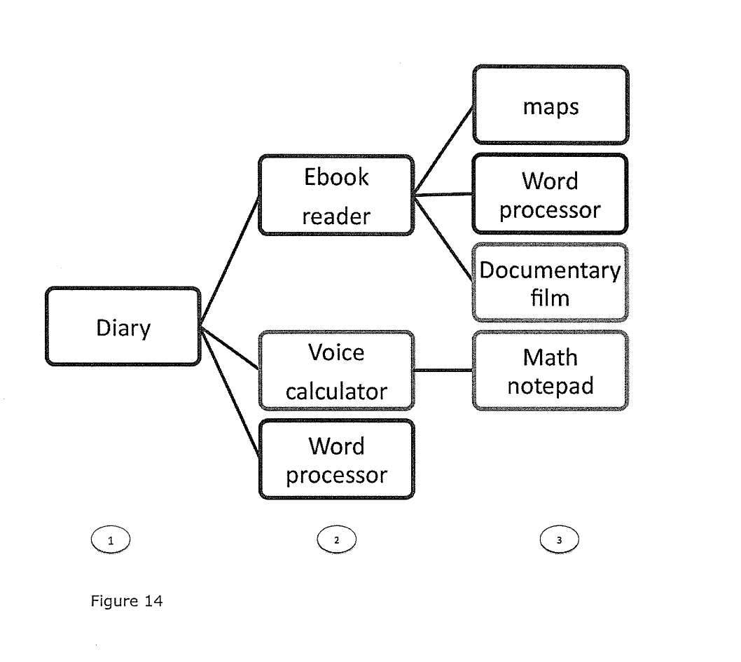

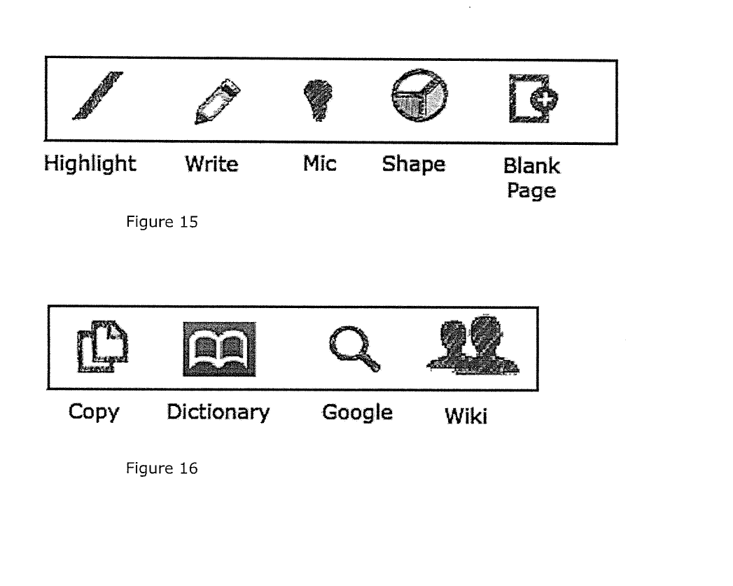

FIG. 14 shows a flowchart representing the main activities of the learning method and their sequences.

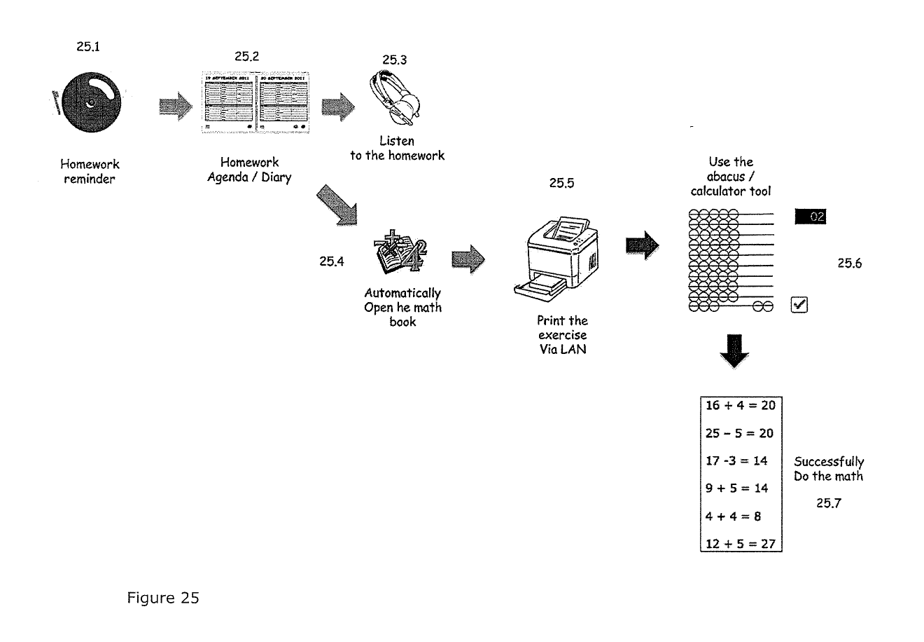

FIG. 25 shows a flowchart of a possible successful execution of math homework by a dyslexic (or dyscalculic student). On the day before the due date the student finds a reminder on his TDC (25.1), the student listen the homework read aloud by the diary application (25.3), the diary opens the math book automatically on the right page (25.4), the student can print the exercise via the Wifi interface of the tablet (25.5), then using the abacus/calculator app he can transform the abstract numbers in something tangible/understandable as abacus balls (25.6) and finally he can do the math and write the answer on the electronic notebook on TDC.

3.0 Students Read their Homework on the Diary

Students will start opening their digital diary (agenda) where they will find their homework (1).

The Diary homework can contain a direct link to the digital schoolbook specific page and it will automatically pass it to the disclosed ebook reader. This way the ebook reader can open the schoolbook right to the proper place to start the reading (2).

Once a dyslexic child needs to study or to do homework, he/she starts by using his “TDC” and with 3 touches he can have his/her text/book read aloud by the device.

In case of math homework, the Diary will contain a link to the math school book containing the exercise or to the notebook.

### 3.1 Reading

Within the ebook reader the student can:

highlight a sentence with different color

add a written note (which is showed as a colored sticky note on the page)

add a vocal (recorded) note

draw lines, circles, square around text and/or images

This way the most significant elements of a page can be made more evident based on the student opinion or teacher/parent ones. Changes and notes will be saved in the document for future use.

Students can select a specific word and find its meaning on the local dictionary (already available on “TDC”), search it against Wikipedia or Google (FIG. 16). Results will be shown in a separate window and can be also read aloud by “TDC”.

Additionally students can add a white page in the ebook—after the page they are reading—where they can write with the onscreen keyboard and insert additional pictures.

### 3.2 Solving Problems

To overcome the calculation difficulties that some dyslexic children are facing, “TDC” contains specific tools to be used in math exercises.

Two different talking calculators are available on “TDC”: they have different functionalities and should be used according to the age of the student.

For primary school:

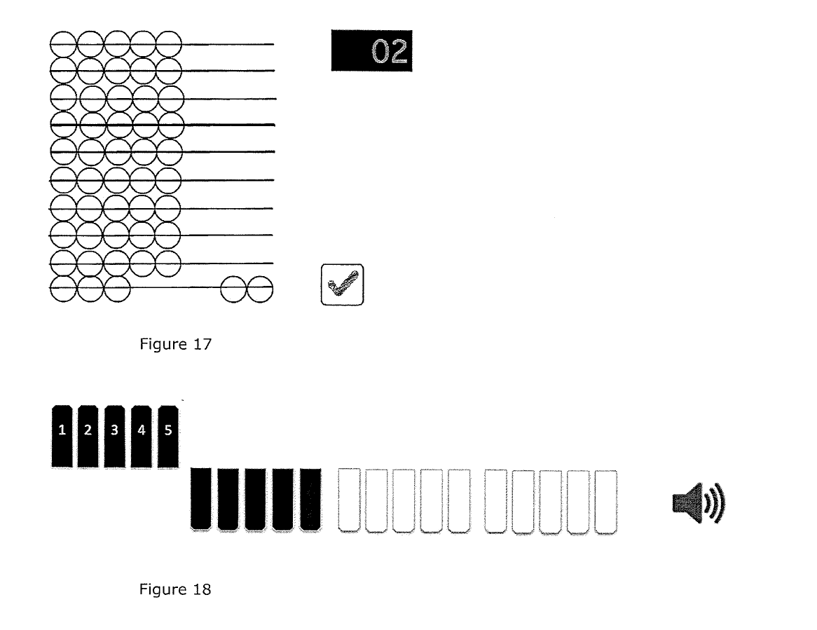

A talking abacus can be chosen to perform the required calculation. When a number is composed on the abacus, by pressing a specific icon, its number is read aloud (FIG. 17).

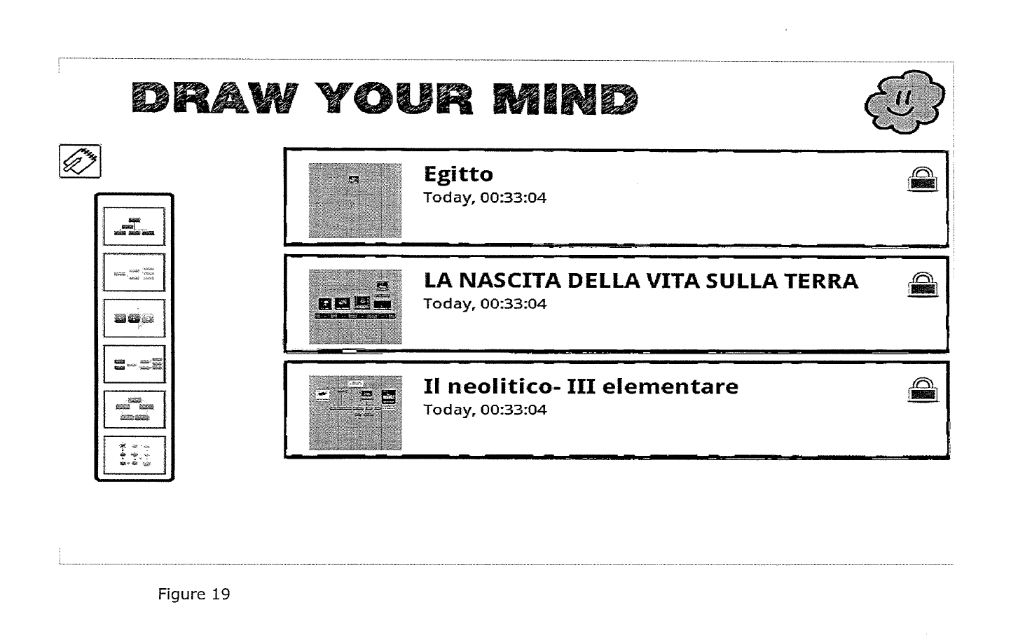

A calculation tool shaped as 4 pair of hands can be used to perform calculations. Students move the fingers up or down to compose a number that can be read aloud on student request (FIG. 19)

A basic calculator with talking functionalities is provided. It provides also a log where inserted operation are shown with the primary school traditional representation

For secondary school:

An advanced (scientific) talking calculator is available. It provides a log where previously inputted calculus are tracked and can be re-read aloud.

A notebook containing the main formulas from geometry to algebra to be available. The notebook contains the formulas on the left and the scientific (talking) calculator on the right. Formulas can be searched within the notebook with a small search engine and can also be added by students on blank pages

A Math notebook with a formula writer (similar to “Math Type”) and a talking calculator aside

### 3.3 Memorizing/Studying Concepts

After reading a lesson, it is time to memorize the main concepts in order to be able to repeat them.

Students will use the disclosed mapping software (a diagram app) to create a visual representation of the topic they need to learn (FIG. 19).

The disclosed mapping software is very intuitive and allows kids to create with few touches, complex maps that include several relation/links among nodes. It is not required anymore for students to learn to use a mouse or to draw complex shapes!

The program has two different mode of use:

Edit mode to allow the student to build a map

View mode to allow the student to study the map

In every moment it is possible to switch from edit mode to view mode (and vice versa) with a single tap.

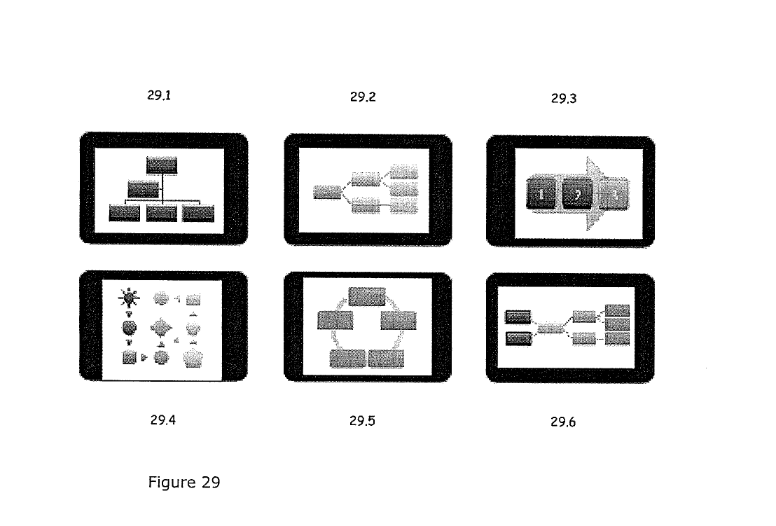

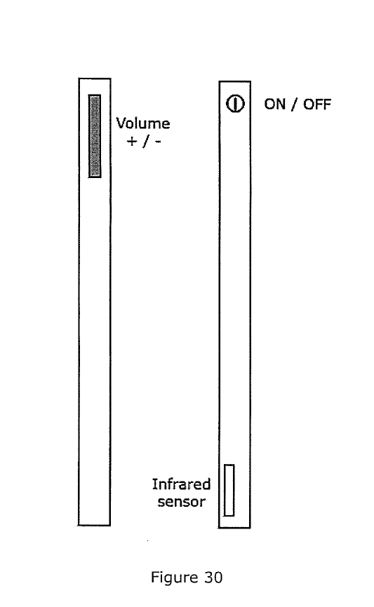

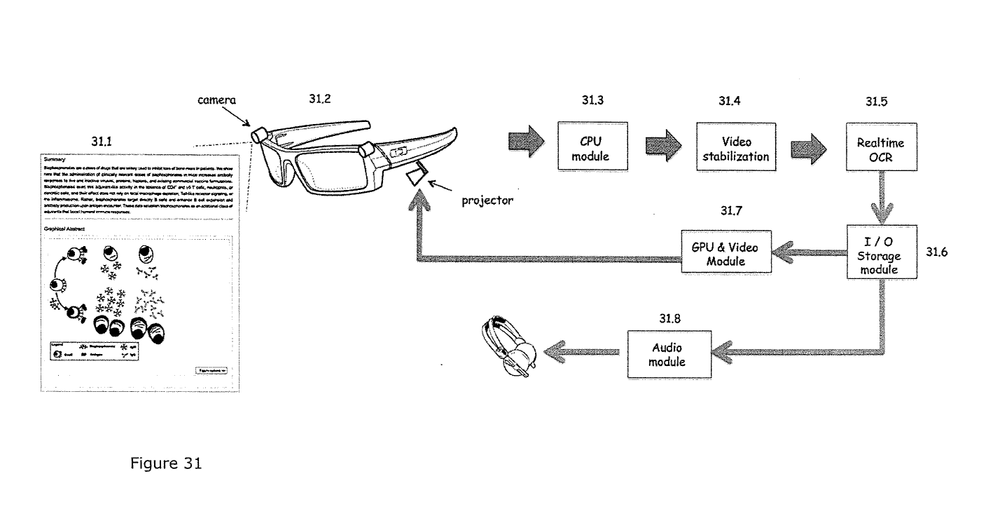

When starting the program in EDIT Mode students can choose (FIG. 29) 5 different predefined map shapes such as:

Vertical (29.1)

Horizontal (29.2)

Bidirectional (29.6)

Timeline (29.3)

Circle (29.5)

As an alternative they can draw diagram with free shapes (29.4).

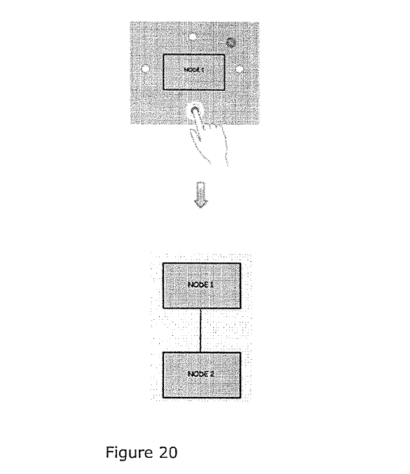

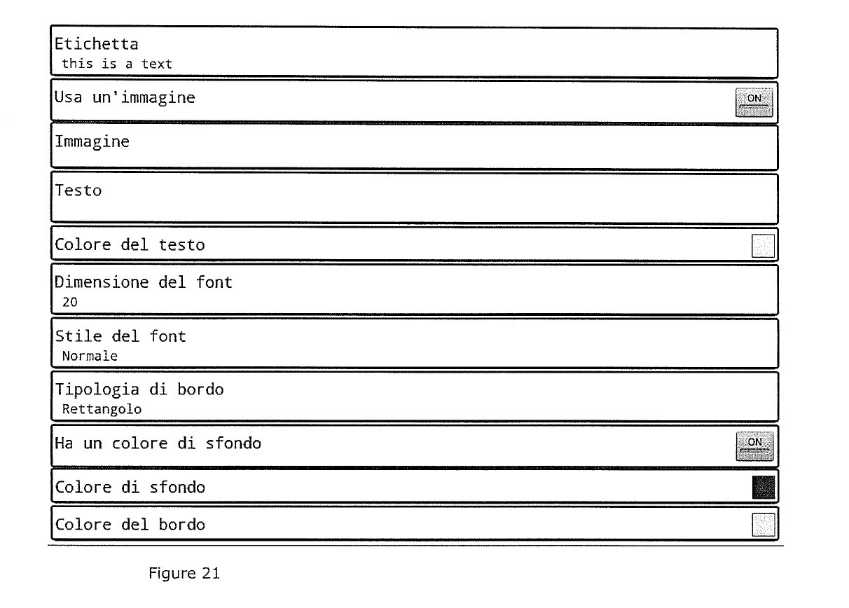

When touching a single node, it automatically shows small dots in the direction the map can develop. Tapping on an individual dot will connect and create a new node in that direction (FIG. 20). Double tapping on a node open the node's properties page (FIG. 21) from which students can:
Type the node title
Associate an image to the node (selecting it from the one already on “TDC” or downloading it from Google)
Add a description to the node
Add a vocal note to the node
Select a specific shape of the node, a border size/color, a filling color, a node font and size, etc.

Once a map is created, student can switch to VIEW mode and use the map to memorize/study that specific topic.

In view mode double tapping on a note can play the associated voice note or automatically read aloud a written text that was associated to the node.

The disclosure of the combination of map, color, shapes, words and associated audio improve dramatically the capability for the dyslexic child to learn.

Map creation can also be started from the ebook program; when a student highlights a word or sentence they can select a specific icon in order to memorize for further use in mapping.

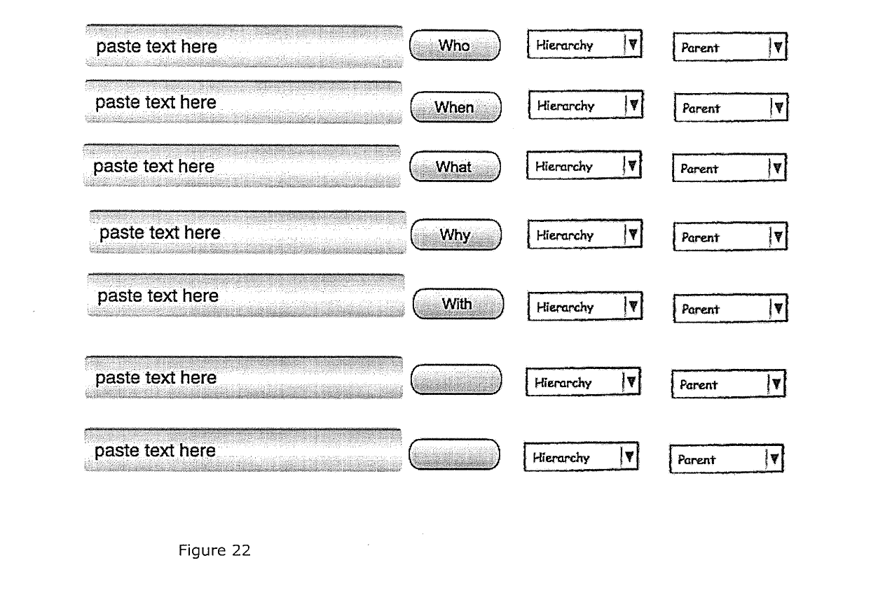

In that case, the student will be requested to link the selected word to one of the 6 available categories:
Main topic/concept
When
Where
How
Who
Why
   In each category 6 items can be added, each of them can have a priority/order number (with also decimals to indicate that two items might be in a parent-son relation). FIG. 22 Those items will be then used to create (automatically or manually) a map.

As an alternative, map skeletons can also be created using a wizard that will guide students in identify main concepts, nodes and their relations by answering to a sequence of questions asked by the program itself.

3.4 Sharing Information with the Teacher

Interaction between teacher and students is very important; in a non-digital world it can have different behavior: one to one, one to many and many to many.

To implement all those possible interaction TDC comes with a cloud based application that provides mechanism to exchange documents, file and homework with the teacher.

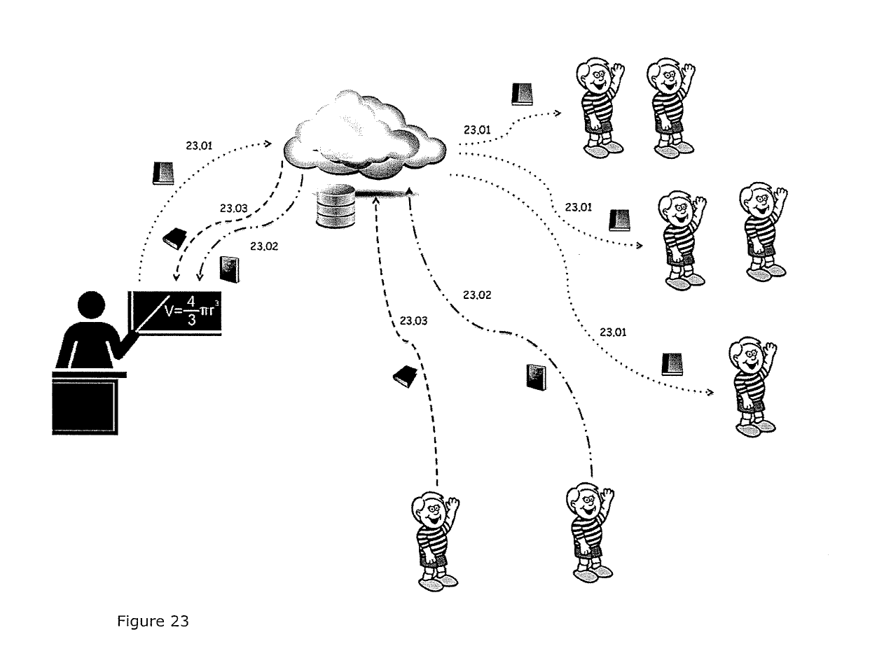

FIG. 23 show a possible example of those interactions: a teacher is sending a book/homework to a group of students with a single submission to the cloud (24.01), individual students can send a specific file/homework to the teacher (24.02 and 24.03).

Interactions groups and mechanism are created by the teacher from an administrative interface where he/she can also create some collaborative rooms where all students contribute to a group exercise.

A dedicated web portal is also available to allow teachers to create appropriate digital content from their Mac/PCs: they can create a digital book structure, add text, images, audio and video and generate an ebook that can be shared to a class or a specific group of kids. Generated ebooks will be able to show text and content in a way that is better manageable by a dyslexic mind (read via the ebook reader, they will use specific fonts, word and line spacing, will contain multimedia data and will be readable via TTS).

Via the web portal teachers could also be able to manage their class devices, control the installed apps and deploy new content.

### 3.5 Collaborative Learning

In past, a front facing lesson where the teacher was the only owner of knowledge, transmitting it to the class, was working very well; recent researches showed that digital natives have a learning process different than the one of previous generations and that the traditional approach is not working properly with them.

Digital natives are used to experience the world leveraging multiple sources, in a multitasking and non linear approach, often exchanging opinions with peers. Multimedia is often involved and it integrates with the other information.

The TDC fully supports a learning approach compatible with this new mindset by acting as an enabler of a collaborative learning environment. TDC can be used to manage a single activity, splitting it in parts to be managed by small groups and then easily recombined in the final group outcome.

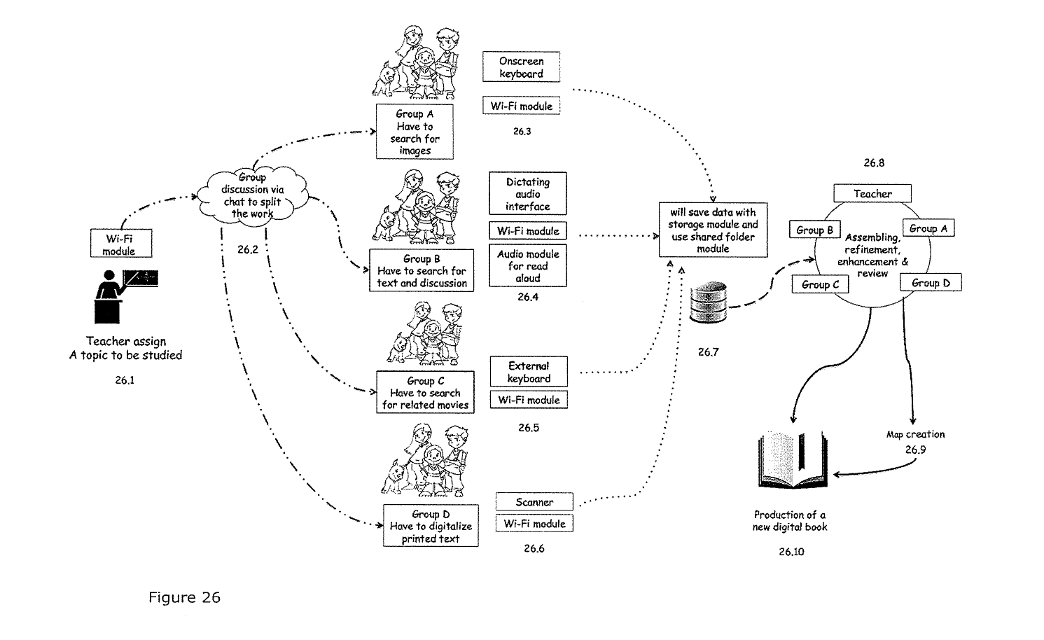

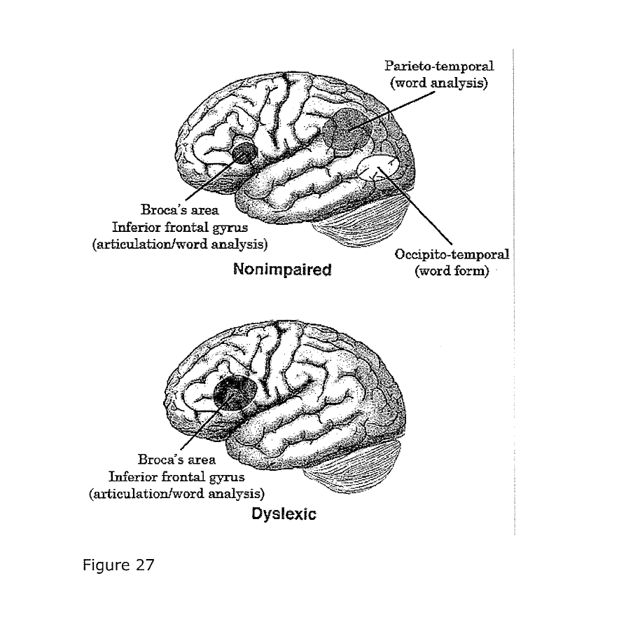

FIG. 26 shows a possible workflow diagram implementing collaborative learning and made possible by the adoption of TDC. A teacher is assigning to the class a study activity (26.1). The class is discussing the topic via chat (26.2) split in groups with different tasks. A group will work on searching on the internet related images (26.3), will classify them and select the most appropriate. Another group will look for related text and articles on the web and Wikipedia (26.4). The third group will look for related movies (26.4). The last group will digitalize pages from existing books using a scanner (26.5). The whole class, with the teacher supervision, will work on analyzing and reviewing all the material (26.8) to produce a completely new book that will be the synthesis of all the material they found (26.10) including the generated maps (26.9)

### 3.6 Gamification & Rewards

In recent years several researches (Huling, Ray—Mar. 25, 2010; Mangalindan, JP—2010; Jane McGonigal Read—2011; Huotari, Kai; Hamari, Juho—2012) described the advantages of the adoption of gamification techniques and interface design to leverage people's natural desires for competition, achievement and status and push them to perform specific tasks.

TDC is designed with this in mind. There are currently two capabilities provided with TDC that can be activated: Reward Points and Badges.

Reward points can be used by teacher/parent for a good work performed by the student. Through the admin interface the adult is able to enter a certain number of points after the completion of a task.

By reaching a certain number of points (configurable by the adult) the student gets time limited access to a specific game.

Badges can be activated by the teacher and work within a class of students using the TDC. Via a web interface the teacher can assign points to a specific students. When a student reaches a certain number of points the student gains a special badge. Students with badges are published on a wall of frame web page and gain a special badge visible on their TDC.

Both the Reward Points and Badges mechanism contribute to increase student motivation to study.

### 3.6 1 Other Activities

The disclosed TDC contains other tools is useful to facilitate the learning experience for dyslexic child as:
a visual foreign language course, a self learning tool that teaches/reinforce the student foreign vocabulary in a natural way
a multimedia player that shows selected documentary made available by the teacher or parent to make easier/more interesting the learning of a specific topic (i.e. before studying Ancient Romans, students are shown a movie on Julius Cesar life; and additionally the player can also reproduce audiobooks)
a messaging program that allow students to communicate among them and with the class via e-mail and/or instant messaging
a web browser with text to speech functionalities. Every web page can be read aloud by the browser at student will
Google maps are used to start to study geography by starting from the satellite view of the kid own house and then zooming out to the village, city, state, country, world

The disclosure includes a system for learning comprising a computer; at least one electronic database coupled to the computing system; at least one software routine executing on the computing system which is programmed to facilitate learning in the manner described; The disclosure includes a method for learning comprising a computer; at least one electronic database coupled to the computing system; at least one software routine executing on the computing system which is programmed to facilitate learning in the manner described. The method comprises the steps of: (a) receiving first data relating the learning experience and relating to the experience to different teaching modules. The disclosure also includes a non-transitory computer-readable medium for determining learning comprising a computer; at least one electronic database coupled to the computing system; at least one software routine executing on the computing system which is programmed to facilitate learning in the manner described and having stored thereon instructions for a computer to execute the medium comprising: at least one electronic database; and at least one software routine comprising instructions for facilitating learning in the manner disclosed. The disclosure relates to a device or devices which includes hardware and software and systems methods to support learning.

The TDC and the disclosed method pushes students to take the initiative of integrating new concepts into their existing cognitive architecture. In the course of a new document production (such as the one created with the maps and/or the one produced via collaborative learning approach—FIG. 26), students not only have to understand a specific topic, have to discern the connections among the different sub-elements, but also must be able to understand where new information gathered from other sources fits in the overall information architecture. The creation process not only helps students to understand their inadequacy (and eventually fill it) but also allows the teacher to see the student way of thinking and help them to focus more on the weak areas.

While the disclosure is susceptible to embodiments in many different forms, there are shown in the drawings and described herein, in detail, some embodiments of the present disclosure. It should be understood, however, that the present disclosure is to be considered an exemplification of the principles of the disclosure and is not intended to limit the spirit or scope of the disclosure and/or the embodiments illustrated.

The apparatus and method have been described in terms of what are presently considered to be the most practical and preferred embodiments, it is to be understood that the disclosure need not be limited to the disclosed embodiments.

It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An education method comprising hardware and software platform having a tablet device, the tablet interface being a primary learning device; and selectively a scanner with automatic document feeder for acquiring documents; comprises the steps of
loading at least one of a school book, narrative book, comic or written material on the device selectively by at least one of wifi, usb or microsd card;
providing a user interface screen, the interface screen having icons, each of the icons occupying between about 10 and 30% of the interface screen, and the size selectively being dependent on implementation; and
selectively providing the interface with a functionality of parental control that allows a teacher or parent to choose the application for a student, and other applications essentially being non-available visually on the device.

2. The method as claimed in claim 1 including providing a panel, selectively PIN protected, for permitting a teacher or parent to configure the device with different programs or to access other available applications to allow the student to play, selectively as a recognition/reward, for work, or selectively providing a game or reward dependent on student results.

3. The method as claimed in claim 1 including providing an agenda with recording/dictating capabilities, school timetable, different colors, alarms/reminders to simplify the process for a student to take notes and not forget homework, and optionally wherein in a view mode, homework in the traditional week view is shown, and also in a single to do list where homework is listed in a chronological order according to the due date.

4. The method as claimed in claim 3 wherein in edit mode the method works in a way where the user is permitted to choose a day by selecting in the week/month view and typing a homework with details; and selectively additionally homework is added by recording on the current day and permitting a student to listen again.

5. The method as claimed in claim 4 wherein in both modes homework is read aloud by the tablet.

6. The method as claimed in claim 1 including an ebook reader functional to reproduce common digital format selectively as txt, HTML, epub, PDF or rtf.

7. The method as claimed in claim 3 wherein the ebook reader includes a touch interface to permit browsing ebooks which once opened, is the essentially only thing shown on the screen.

8. The method as claimed in claim 1 including a toolbar with the different commands to perform on an ebook, and being visible if the screen is touched for a prolonged time, and in the absence of actions, disappears whereby there are essentially no distractions on the screen, the screen being essentially filled by the ebook.

9. The method as claimed in claim 1 including a text to speech functionality, whereby an ebook is read aloud by the device, and including an icon of the ebook toolbar to activate the text to speech starting from the first word of a shown page.

10. The method as claimed in claim 1 including a reading aloud function, a stop function before the completion of a page by pressing a specific icon; a pause and restart function, and wherein reading speed is increased or decreased according to a student preference.

11. The method as claimed in claim 3 wherein the ebook reader includes a karaoke functionality that visually highlights on screen the sentence being read by a text to speech engine.

12. The method as claimed in claim 1 including an on-screen keyboard with dictating feature, an on-the-fly spell checker of what is typed, highlighting relative to an internal dictionary, and an option for read aloud and optionally including a mapping tool to permit representing concepts of a topic needed to study in a map.

13. The method as claimed in claim 1 including optional glasses with camera, selectively as a head mounted display, enabled to augment perceived reality by enrichment with additional intelligible information, and enabled to recognize written text, capture text and read text aloud.

14. The method as claimed in claim 1 including a multi-language dictionary operable as a standalone application or invoked within a different application, selectively an ebook reader, and selectively the dictionary performs a search as you type feature that shows on the fly words matching the inserted letters, and optionally wherein once found the word, and the word definition is shown on a screen with hyperlinks to other words mentioned in the definition, and selectively the definition and selectively the searched word is read aloud by pressing an icon

15. The method as claimed in claim 1 wherein students start learning by opening a digital diary to find homework, and selectively a direct link to the digital schoolbook specific page and passing to the disclosed ebook reader to open at a proper place to start the reading and optionally wherein for reading within the reader the student is enabled to:
highlight a sentence with different color;
add a written note and which is selectively shown as a colored sticky note on the page;
add a vocal, selectively recorded, note; and
draw lines, circles, square around text and/or images.

16. The method claimed in claim 1 including providing a tool for math exercises, and including two different talking calculators, selectively for primary school:
including choosing a talking abacus to perform a calculation, when a number is composed on the abacus, by pressing a specific icon, and the number is read aloud;
providing a calculation tool, selectively shaped as 4 pair of hands to perform calculations, wherein selectively students move fingers up or down to compose a number read aloud on student request; and
providing a calculator with talking functionality and a log where inserted operation is shown with the primary school traditional representation.

17. The method as claimed in claim 1 including providing a tool for math exercises, and including two different talking calculators, selectively for secondary school, and:
providing an advanced scientific talking calculator, and selectively providing a log where previously inputted calculus is tracked and for being re-read aloud;
providing a notebook containing the main formulas from geometry to algebra, the notebook containing formulas and selectively formulas being searchable within a notebook with a search engine and added by students; and
providing math notebook with a formula writer.

18. The method as claimed in claim 1 including permitting after reading a lesson, a memorization functionality, using the mapping software to create a visual representation of the topic to be learnt.

19. The method as claimed in claim 1 wherein the mapping program has two different mode of use, selectively:
edit mode which allow the student to build a map; and
view mode which allows student to study the map; and
the possibility to switch from edit mode to view mode with a single tap.

20. The method as claimed in claim 1 including touching a single node to show dots in a direction the map develops; tapping on a dot to connect and create a new node in that direction; and double tapping on a node to open the node properties page from which students can:
type the node title
associate an image to the node, selectively selecting the image from the one already on or downloading it from Google
add a description to the node
add a vocal note to the node
selectively select a specific shape of the node, a border size/color, a filling color, a node font and size and optionally wherein when a map is created, to permit a student to switch view mode and use the map to memorize/study that specific topic, and selectively in view mode double tapping on a note play the associated voice note or read aloud a written text associated to the node; or
optionally include the combination of map, color, shapes, words and associated audio to learn; map creation to start from an ebook program;
when a student highlights a word or sentence to memorize for further use in mapping, and a link the selected word to one of the categories: selectively being the Main topic/concept; When; Where; How; Who; or Why.
